(19) United States
(12) Patent Application Publication
(10) Pub. No.: US 2013/0183842 A1
(43) Pub. Date: Jul. 18, 2013

(54) Electrical Connector

(71) Applicant: Tyco Electronics Japan G.K., Kanagawa-ken (JP)

(72) Inventors: Seiji Shishikura, Chiba (JP); Hiroyuki Iketani, Kanagawa (JP)

(73) Assignee: TYCO ELECTRONICS JAPAN G.K., Kanagawa-ken (JP)

(21) Appl. No.: 13/720,111

(22) Filed: Dec. 19, 2012

(30) Foreign Application Priority Data
Dec. 28, 2011 (JP) 2011-288050

(51) Int. Cl. H01R 13/447

(52) U.S. Cl. CPC H01R 13/447
USPC 439/147

(57) ABSTRACT

The invention relates to an electrical connector having a plurality of contact housings and a lock housing. The plurality of contact housings are vertically positioned upon each other. Each contact housing having a first end, a second end, and a step portion disposed between the first end and the second end. The lock housing includes a cover plate extending across an upper side of the plurality of contact housings and a lock arm extending from the cover plate and engageable with at least one of the plurality of contact housings. The lock arm includes an end portion engageable with the step portion.

### CROSS-REFERENCE TO RELATED APPLICATIONS

This application claims the benefit of the filing dates under 35 U.S.C. §119(a)-(d) of JP Patent Application No. 2011-288050, filed on Dec. 28, 2011.

### FIELD OF THE INVENTION

The invention relates to an electrical connector and, more particularly, to an electrical connector having stacked contact housings.

### BACKGROUND

In recent years, the number of terminals for an electrical connector (hereinafter, an electrical connector is sometimes referred to simply as “connector”) for use in the field of automobiles and the like has increased.

Accordingly, there is a known electrical connector having multi-stacked and combined contact housings, wherein each housing accommodates a plurality of terminals aligned side by side in one direction (for example, as disclosed in Japanese Patent Laid-Open No. 2007-95360 and Japanese Patent Laid-Open No. 2011-96397). Each of the stacked contact housings includes a protrusion and an engaging piece to be engaged with this protrusion, formed on its side face. Thus, the vertically aligned contact housings are coupled together when the protrusion of one of the contact housings engages with an engaging piece on the other contact housing.

With reference to FIG. 5, a known connector 3 is shown having a lock housing 2 that couples with a plurality of stacked contact housings 1. For each contact housing 1, a recess 5 is disposes along a lower surface 1c side thereof, while a protrusion 6 is disposes on an upper surface 1d side, which is opposite to the lower surface side 1c. Accordingly, the contact housings 1 can vertically align and stack upon each other when a catch formed on a tip of the protrusion 6 couples with an engaging member formed on the recess 5.

Moreover, when the contact housings 1 are stacked, the protrusion 6 of the lower one of the contact housings 1 enters into the recess 5 of the upper one of the contact housings 1. As a result, movement of the stacked contact housings 1 relative to each other can be prevented. A first face 1a and a second face 1b (on the opposite side thereof) of each of the contact housing 1 can maintain alignment with respect to each other, as stacked.

However, in the above-mentioned structure, a length of the protrusion 6 is made smaller than a length of the recess 5 so as to easily engage the recess 5 and the protrusion 6 with each other. For this reason, a clearance C is formed between the recess 5 and the protrusion 6 along the respective lengths. As a result, a certain amount of positional displacement may occur within the clearance C between the contact housings 1 when vertically aligned with each other.

In the case when, as shown in FIG. 5, the connector 3 includes stacked contact housings 1 (for example, five stages in FIG. 5), if all the paired contact housings 1 all vertically aligned with each other are displaced in the same direction, the lowermost contact housing 1 is considerably displaced relative to the lock housing 2, as shown in FIG. 6. As a result, a contact held on the contact housing 1 with the great amount of displacement and a contact held on the counter connector may not ensure an effective mating length.

### SUMMARY

In view of this technical problem, an electrical connector according to the invention is provided. The electrical connector includes a plurality of contact housings and a lock housing. The plurality of contact housings are vertically positioned upon each other. Each contact housing having a first end, a second end, and a step portion disposed between the first end and the second end. The lock housing includes a cover plate extending across an upper side of the plurality of contact housings and a lock arm extending from the cover plate and engageable with at least one of the plurality of contact housings. The lock arm includes an end portion engageable with the step portion.

### BRIEF DESCRIPTION OF THE DRAWINGS

The invention will be explained in greater detail in the following with reference to embodiments, referring to the appended drawings, in which:

FIG. 1 is a front, top perspective view that shows an electrical connector according to the invention;

FIG. 2 is a rear, bottom perspective view of the electrical connector of FIG. 1;

FIG. 3 is an exploded perspective view of the electrical connector of FIG. 1;

FIG. 4 is a side view of the electrical connector of FIG. 1;

FIG. 5 is a perspective view of a known electrical connector; and

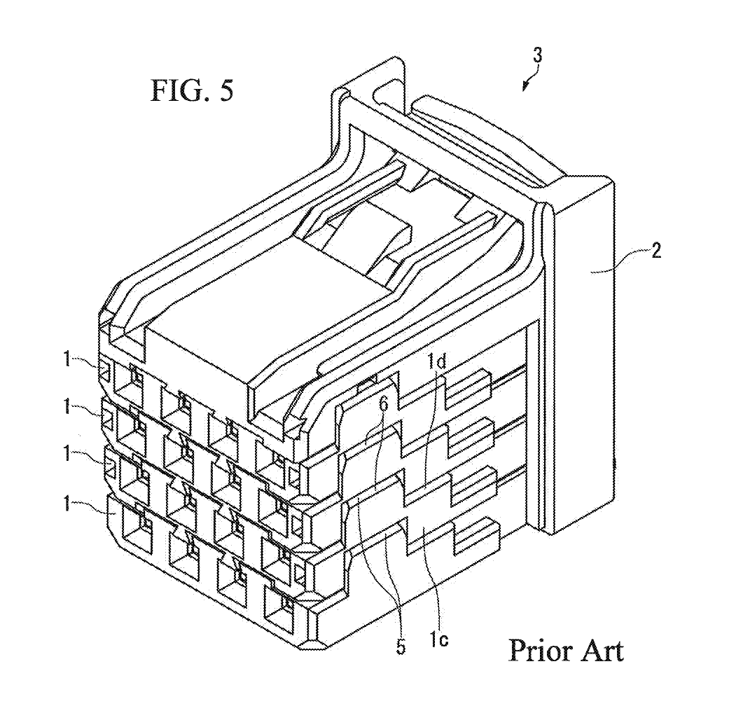

FIG. 6 is a side view of the known connector of FIG. 5.

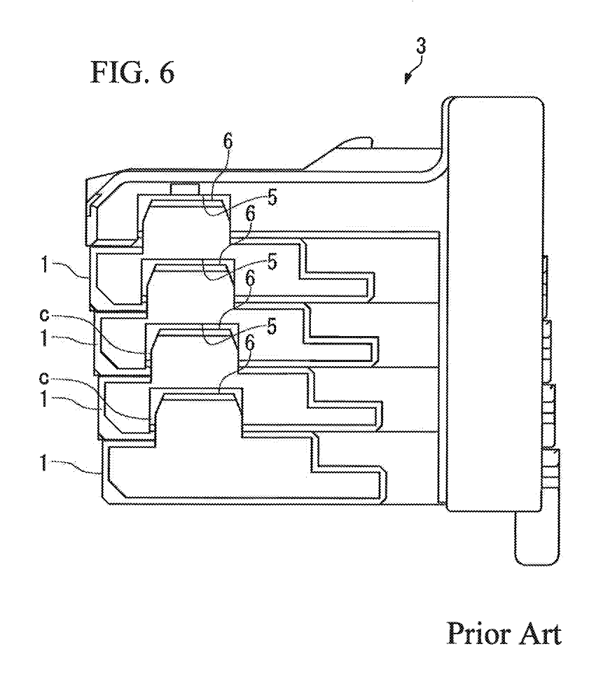

### DETAILED DESCRIPTION OF THE EMBODIMENTS

The following description will discuss the present invention in detail based upon embodiments illustrated in the attached drawings.

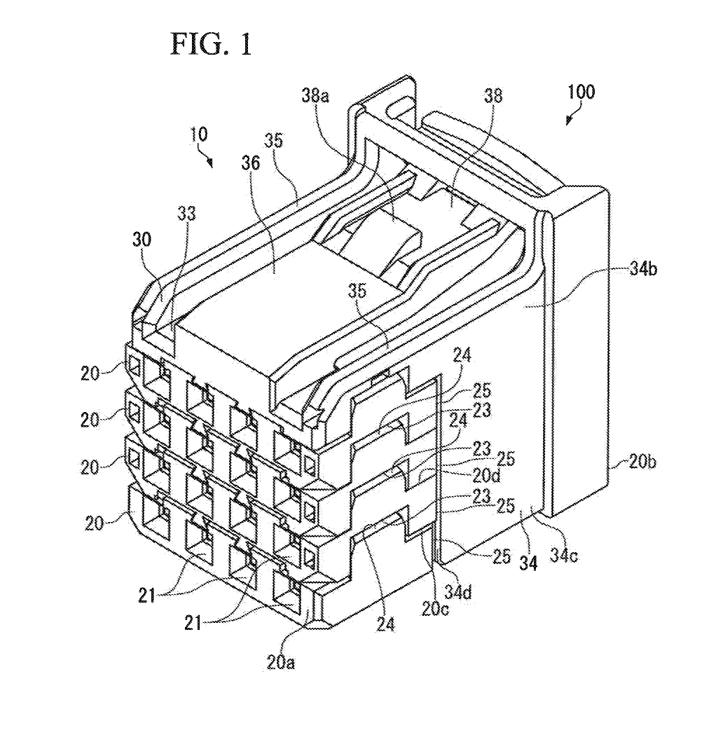

As shown in FIGS. 1 to 4, an electrical connector 100, such as a male connector, to be mated with a mating connector (not shown), such as a female connector, is shown. In the embodiment shown, the electrical connector 100 includes a housing 10 that accommodates a plurality of female contacts (not shown).

The housing 10 of the electrical connector 100 is made of an insulating material such as a resin.

The housing 10 includes a plurality of stacked contact housings 20 (four stages in the shown embodiment) and a lock housing 30 that engages with all of the contact housings 20. Each contact housing 20 is stacked vertically upon one another.

Each of the contact housings 20 includes a plurality of contact receiving passageways 21 formed side by side along one another. Each contact receiving passageway 21 penetrates from through the contact housing 20, from a first face 20a to a second face 20b which is opposite the first face 20a. A female contact (not shown) made of a conductive material may be inserted into the contact receiving passageway 21. Furthermore, in each contact housing 20, a wire (not shown) connected to the female contact (not shown) is drawn from the second face 20b side.

A recess 23 is disposed on a lower face 20c side of each contact housing 20, while a protrusion 24 disposed on the upper face 20d side of each contact housing 20.

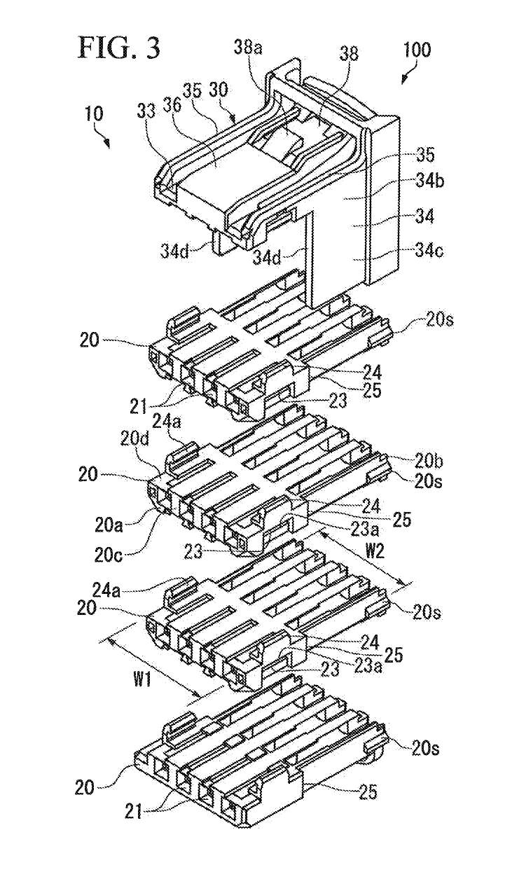

A catch 24a is disposed on a tip of the protrusion 24, and is meant to engage with an engaging member 23a disposed along the recess 23 (see FIG. 3). As a result, the contact housings 20 may vertically aligned with each other when stacked and coupled together.

Furthermore, upon vertically stacking a plurality of contact housings 20, the protrusion 24 of the contact housing 20 (located below) is inserted into the recess 23 of the other contact housings 20 (located above). As a result, movement of the stacked contact housings 20 is prevented, such that displacement of an individual contact housing 20 from an alignment of the second faces 20b is prevented.

In this case, each contact housing 20 is formed such a housing width W1 of the first face 20a side, including a portion having the recess 23 and the protrusion 24, is larger than a housing width W2 on the second face 20b side. Accordingly, a step portion 25 is disposed along a middle portion of opposite side faces of the contact housing 20, between first face 20a and the second face 20b.

The lock housing 30 includes a cover plate 33 that covers an upper side of the stacked plural contact housings 20 and lock arms 34 extending from the cover plate 33 and along the two opposite side faces of the stacked contact housings 20.

The cover plate 33 includes a pair of outer protruding bars 35 and an inner protruding bar 36 that extend upward from a major surface thereof, and extend from a front end to a rear end in the embodiment shown. The outer protruding bars 35 are formed on two opposite sides along a width of the cover plate 33, while the inner protruding bar 36 is disposed along a substantial center portion along the width direction, between the pair of outer protruding bars 35. The outer and inner protruding bars 35, 36 are inserted into guide grooves formed in the mating connector, so that the inserting direction of the electrical connector 100 relative to the mating connector is guided.

An elastic locking member 38 that substantially extends in parallel with the cover plate 33 is formed on the rear end portion of the inner protruding bar 36. A locking catch 38a is formed on the upper surface of this elastic locking member 38. This locking catch 38a is engaged with an engaging recess (not shown) formed on an inner circumferential surface of the female connector so that the housing 10 stays mated with the female connector housing during assembly.

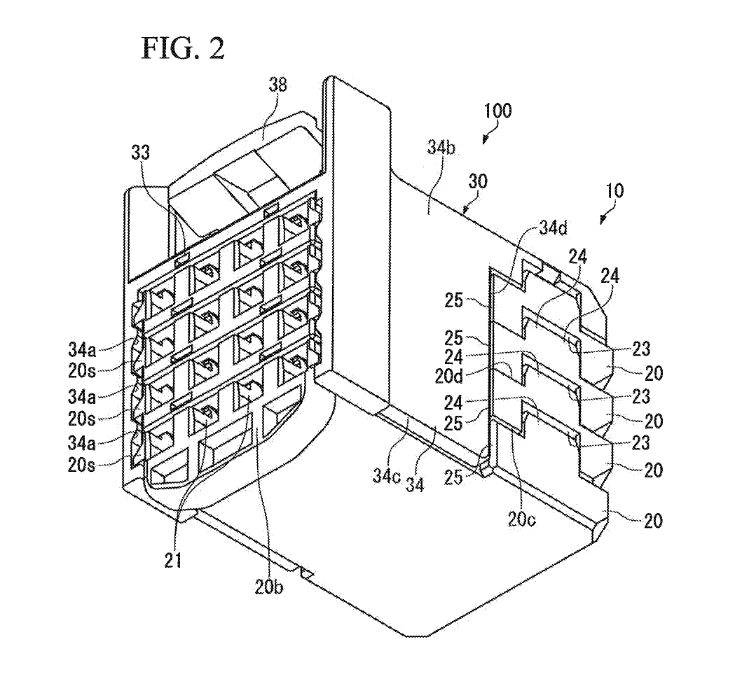

Each lock arm 34 extends downward from opposite sides of the cover plate 33 such that the lock arms follow the two opposite side faces of the stacked contact housings 20. Each lock arm 34 includes engaging protrusions 34a on the side facing the stacked contact housings 20 (see FIG. 2). The engaging protrusions 34a engage with protrusions 20s formed on the rear end portions of each of the contact housings 20.

Each lock arm 34 includes a base portion 34b extending downward from the cover plate 33 and a tip 34c extending from the base portion. The tip 34c is elastically deformable in a direction orthogonal to the side faces of the stacked contact housings 20, that is, moving away from the side face around the base portion 34b.

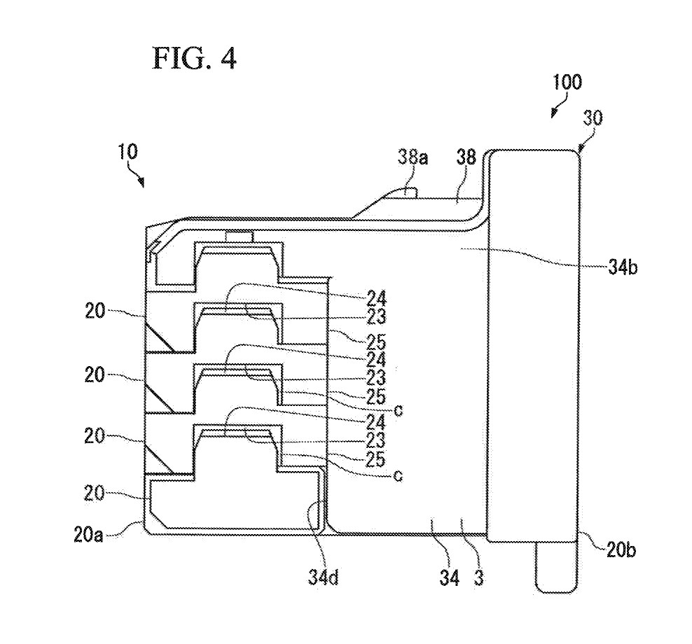

Each lock arm 34 includes an end portion 34d having a linear shape that extends along the stacking direction of the contact housings 20 as shown in FIGS. 3 and 4.

Thus, each lock arms 34 extends along the two opposite side faces of the stacked contact housings 20, and allows each of the engaging protrusions 34a to engage with the protrusion 20s of each of the contact housings 20, along each respective stage thereof. As a result, the lock housing 30 integrally couples all of the stacked contact housings 20, and the end portion 34d of the lock arm 34 faces each of the step portions 25 of the stacked contact housings 20. In addition, the step portions 25 abut against the end portions 34d of the lock arms 34, respectively, and consequently the stacked contact housings 20 are restricted from linearly moving out of alignment with respect to the first and second faces 20a, 20b.

As described above, the lock housing 30 integrally couples each of the contact housings 20 to one another, with the end portion 34d of each lock arm 34 facing the step portion 25 of each contact housing 20. As a result, even when a clearance C is formed between the recess 23 and the protrusion 24 of two stacked contact housings 20, the contact housing 20 on each stage is restricted from linearly moving toward the second face 20b side because the step portion 25 abuts against the end portion 34d of each lock arm 34. With this arrangement, it is possible to prevent a large positional displacement from occurring between the contact housings 20 and consequently ensures a sufficient mating connection between the electrical connector 100 and the mating connector.

The structures of the electrical connector described above are merely exemplary and may be modified to any other structures without departing from the gist of the present invention.

For example, the lock arms 34 are disposed along two opposite sides of the cover plate 33, but could be installed only on either one of the sides.

Furthermore, the structure as described includes engaging protrusions 34a that engage each of the contact housings 20, stacked on top of one another. However, the invention is not limited to this structure. Rather, the lock housing 30 may be used that only engages with the lower most contact housing 20 of the stacked structure.

Furthermore, the structure as described includes four stages of stacked contact housings 20. However, one skilled in the art would appreciate that the structure could be prepared using two or more stacked contact housings 20.

Besides, the structure described in the above embodiment can be selected or can be changed as appropriate to another structure without departing from the gist of the present invention.

What is claimed is:

1. An electrical connector comprising:
a plurality of contact housings vertically positioned upon each other, each contact housing having a first end, a second end, a step portion disposed there between; and
a lock housing comprising:
a cover plate extending across an upper side of the plurality of contact housings; and
a lock arm extending from the cover plate and engageable with at least one of the plurality of contact housings and having an end portion engageable with the step portion.

2. The electrical connector according to claim 1, wherein one of the plurality of contact housings includes a housing protrusion disposed on a first side along a rear end portion thereof.

3. The electrical connector according to claim 2, wherein the lock arm further includes an engaging protrusion disposed along an inner surface thereof and engageable with the housing protrusion.

4. The electrical connector according to claim 1, wherein the cover plate includes a pair of outer protruding bars disposed along a major surface thereof.

5. The electrical connector according to claim 4, wherein the cover plate further includes an inner protruding bar extending upward from the major surface and positioned between the pair of outer protruding bars.

6. The electrical connector according to claim 5, wherein the lock housing further includes an elastic locking member extending parallel with the major surface and positioned on a rear end portion of the inner protruding bar.

7. The electrical connector according to claim 6, wherein the elastic locking member includes a locking catch disposed on an upper surface thereof.

8. The electrical connector according to claim 1, wherein the lock arm includes a base portion extending downward from the cover plate and a tip extending from the base portion.

9. The electrical connector according to claim 8, wherein the tip is elastically deformable in a direction orthogonal to a side of the plurality of contact housings.

10. The electrical connector according to claim 1, wherein each contact housing includes a recess disposed on a lower surface thereof.

11. The electrical connector according to claim 10, wherein each contact housing further includes a protrusion disposed on an upper surface thereof and corresponding with the recess of an adjacent contact housing.

12. The electrical connector according to claim 1, wherein a width of the first end is greater than a width of the lock housing and a width of the second end.

13. The electrical connector according to claim 12, wherein the width of the lock housing is greater than the width of the second end.
